(19) United States
(12) Patent Application Publication
(10) Pub. No.: US 2020/0061541 A1
(43) Pub. Date: Feb. 27, 2020

(54) METHODS AND SYSTEMS FOR CONCENTRATING DIGESTATE FROM BIOGAS

(71) Applicant: FLUID TECHNOLOGY SOLUTIONS (FTS), INC., Albany, OR (US)

(72) Inventors: John Herron, Albany, OR (US); Edward Gerard Beaudry, Albany, OR (US)

(21) Appl. No.: 16/461,081

(22) PCT Filed: Nov. 16, 2017
(86) PCT No.: PCT/US2017/062066

§ 371 Date: May 15, 2019

Related U.S. Application Data
(60) Provisional application No. 62/423,666, filed on Nov. 17, 2016.

(51) Int. Cl. B01D 61/00; B01D 61/58; C02F 9/00; C05B 7/00; C05F 17/00; C05F 7/00; C02F 1/00; C02F 1/44; B01D 61/02; C02F 1/52; C02F 11/04; C02F 3/02

(52) U.S. Cl. CPC B01D 61/005; C02F 2101/105; C02F 9/00; C05B 7/00; C05F 17/0018; C05F 7/00; C02F 1/001; C02F 1/441; B01D 61/025; C02F 1/445; C02F 1/5236; C02F 11/04; C02F 3/02; B01D 2311/06; B01D 2311/18; B01D 2311/25; B01D 2311/2688; B01D 61/58

(57) ABSTRACT

Embodiments disclosed herein are directed to methods and systems of concentrating effluent, removing nitrogen from an effluent, and producing fertilizer from an effluent. In an embodiment, the effluent is a digestate, such as from a biomass digester. In an embodiment, the digestate is concentrated and nitrogen is removed by performing forward osmosis using a draw solution and the digestate as a feed solution. The draw solution is subjected to reverse osmosis to produce an ammonium salt fertilizer. Phosphorus in the effluent may be precipitated as a struvite fertilizer.

### CROSS-REFERENCE TO RELATED APPLICATIONS

This application claims priority to U.S. Provisional Application No. 62/423,666 filed on Nov. 17, 2016, the disclosure of which is incorporated herein, in its entirety, by this reference.

### BACKGROUND

Anaerobic treatment of organic wastes has become widespread due to benefits including reduction of biological oxygen demand (“BOD”) in the waste, production of methane, which can be burned to generate electricity, and fertilizer value in the digester effluent. Capturing the full fertilizer value of the effluent is challenging because effluent production is year-round while, in temperate zones, fertilizer is only needed during the growing season. In some climates, land application of digester effluent during the winter is prohibited because it causes run-off of nutrients into waterways.

Digestate volumes from biomass digesters can be large. For example, a digester producing two megawatts of power from food and farm waste may generate 100 tons of effluent per day. If all waste is applied to land only during the growing season, storage for 250 days of digestate is required. Tankage to hold the full 25,000 m³ is very capital intensive. The fertilizer value of most digestate is less than 5000 ppm nitrogen, which does not justify the expense of storage tanks.

Fertilizer value in the digestate arises from potassium or phosphorus fed to the digester, as well as ammonia formed during digestion. In anaerobic digesters, bacteria convert oxygen-containing organic compounds such as carbohydrates and cellulose to carbon dioxide and methane gas. Nitrogen in organic compounds such as protein or chlorophyll is converted to ammonia Ammonia in digestate generally reacts with carbon dioxide to form ammonium bicarbonate in solution.

Digester effluent from biomass digesters fed by waste from dairies or animal feedlots is particularly high in ammonia due to the breakdown of urea. Land spreading of such biomass effluent is a major cause of nitrogen contamination of lakes, rivers, and groundwater.

Environmental hazards from phosphorous also restricts the land application of biomass effluent. Precipitation and collection of phosphorous as struvite from single-strength effluent is often not economical due to low phosphorous concentrations.

Accordingly, there exists a need to recover nutrients from digestate by economically viable and environmentally friendly methods.

### SUMMARY

Embodiments disclosed herein are directed to methods and systems for concentrating effluent, removing nitrogen from effluent, and producing fertilizers. In an embodiment, a method of concentrating digestate from a biomass digester is disclosed. The method includes filtering solid matter from the digestate to produce a filtered digestate. The filtered digested has an amount of ammonia in it. Forward osmosis is performed using a draw solution and the filtered digestate as a feed solution. A digestate concentrate, which has an amount of ammonia in it, is produced from forward osmosis. The amount of ammonia in the digestate concentrate is less than amount of ammonia in the filtered digestate.

In an embodiment, a method of removing nitrogen from a feed solution is disclosed. A feed solution is provided, which includes nitrogen in the form of at least ammonia and ammonium ions. A draw solution is also provided. Forward osmosis is performed with the feed solution and the draw solution to transfer ammonia from the feed solution to the draw solution. The method reduces the amount of nitrogen in the feed solution by up to about 50%.

In another embodiment, a method of producing fertilizer is disclosed. Forward osmosis is performed with a feed solution and a draw solution. A diluted draw solution is produced from the draw solution. The draw solution has a percentage of ammonium ions that is greater than a percentage of ammonia. Reverse osmosis is performed on the diluted draw solution to produce a concentrate. Ammonium ions in the diluted draw solution react with an acid in the diluted draw solution to produce an ammonium salt in the concentrate, which forms a fertilizer.

In another embodiment, a method of processing digestate from a biomass digester is disclosed. The method includes filtering solid matter from the digestate to produce a filtered digestate. Forward osmosis is performed using a draw solution and the filtered digestate as a feed solution. A digestate concentrate and a diluted draw solution are produced from the filtered digestate and the draw solution. Reverse osmosis is performed on the diluted draw solution to produce a concentrate. Ammonium ions in the diluted draw solution react with an acid in the diluted draw solution to produce an ammonium salt in the concentrate, which forms a fertilizer. Magnesium salt is added to the feed solution to produce struvite, which forms a fertilizer. The amount of ammonia in the filtered digestate is greater than the amount of ammonia in the digestate concentrate. The amount of ammonia in the diluted draw solution is greater than an amount of ammonia in the draw solution. The diluted draw solution has an amount of ammonia that is less than the amount of ammonium ions in the diluted draw solution.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical elements or features in different views or embodiments shown in the drawings.

FIG. 1 is a flow diagram of a method of concentrating digestate and producing fertilizer, according to an embodiment;

FIG. 2 is a schematic view of a method of concentrating digestate from biomass, according to an embodiment; and

FIG. 3 is a schematic view of a method of concentrating digestate from biomass, according to an embodiment.

### DETAILED DESCRIPTION

Embodiments disclosed herein are directed to methods and systems of concentrating effluent, such as a digestate from a biomass digester; removing nitrogen from a feed solution, which may be a digestate; and producing fertilizer, such as from a digestate.

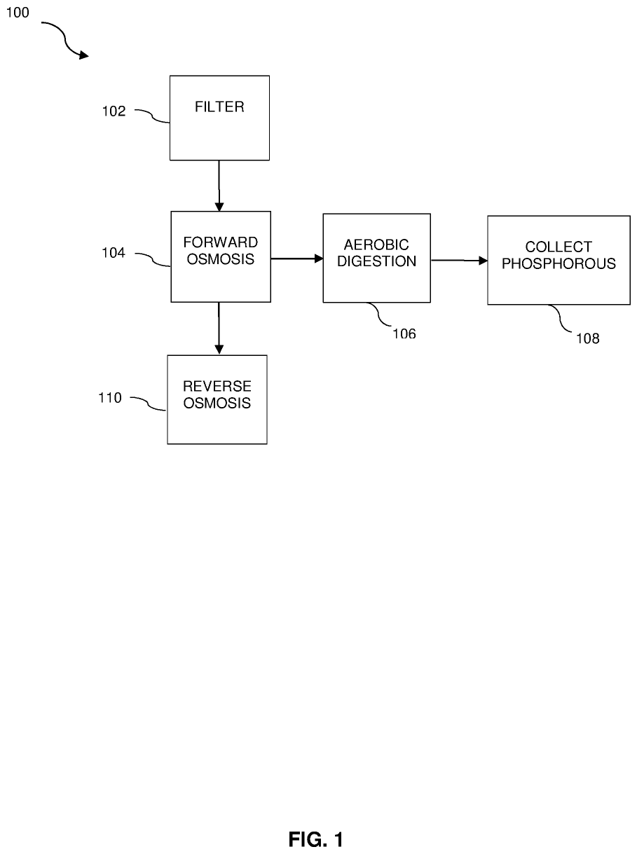

With reference to FIG. 1, the disclosed methods include one or more of a step 102 of filtering the digestate; a step 104 of performing forward osmosis on the digestate or filtered digestate to produce an effluent concentrate; a step 106 of aerobically digesting at least one of the digestate, filtered digestate, and digestate concentrate to reduce the amount of undigested cellular material therein; a step 108 of collecting phosphorus from the digestate, filtered digestate, or digestate concentrate to produce a struvite fertilizer; and a step 110 of performing reverse osmosis on the draw solution from the forward osmosis step to produce an ammonium salt fertilizer. Each step 102, 104, 106, 108, 110 may be performed alone or in combination. For example, some methods include a step of forward osmosis without some or all of the other disclosed steps. As another example, some methods include a step of reverse osmosis without some or all of the other disclosed steps. The example method 100 shown in FIG. 1 includes all of the foregoing steps.

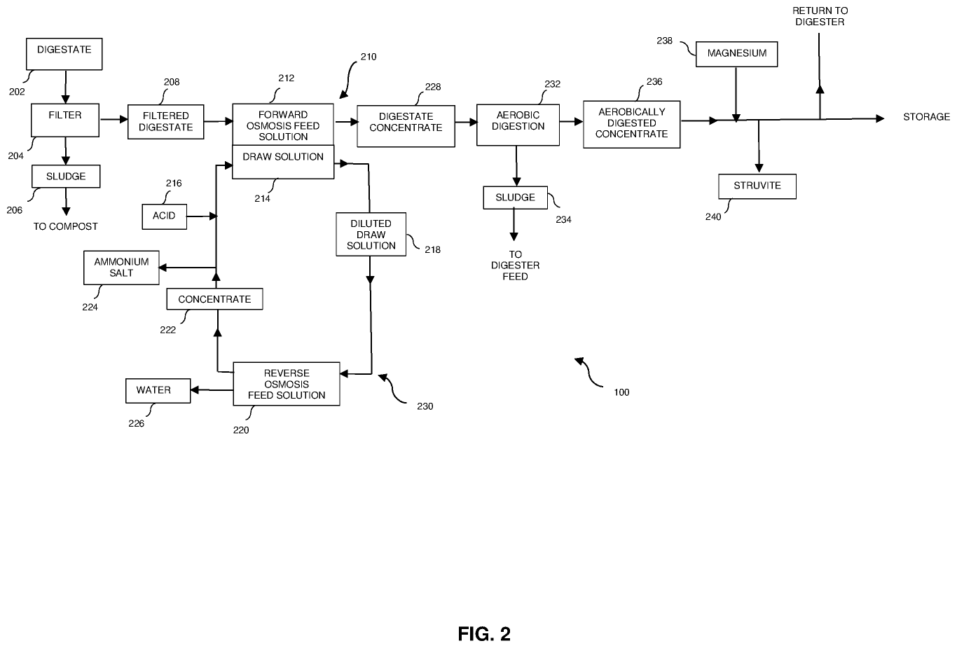

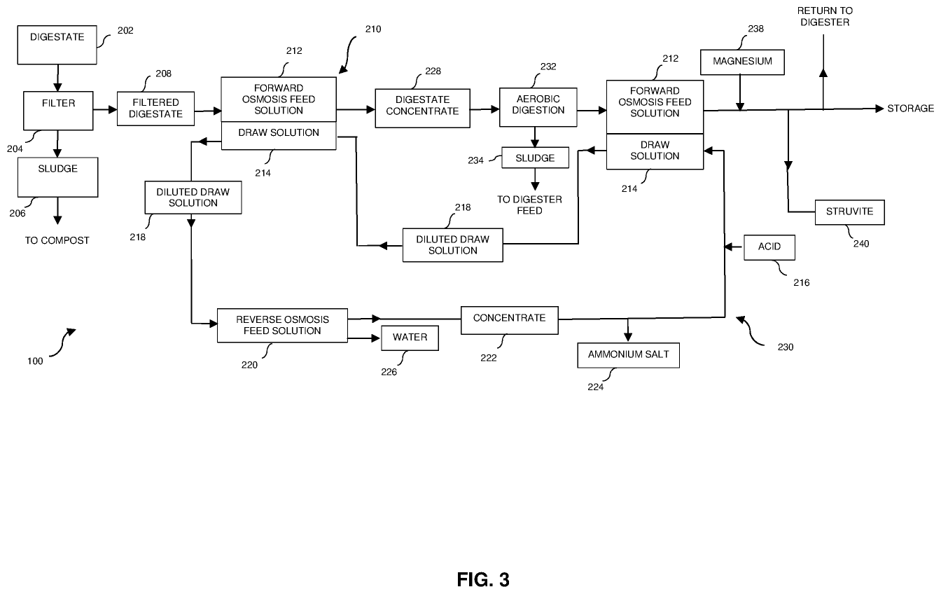

A starting material for use in the disclosed systems and methods may be a digestate, leachate, or effluent from other biomaterial processing streams. In the examples of FIGS. 2 and 3, the digestate 202 may be obtained from an anaerobic processor, such as a commercial biomass digester. The leachate may be extracted from a landfill. Although the term “digestate” is regularly used herein, it is to be understood that other starting materials could be concentrated by the systems and methods disclosed herein.

### Filtration

The raw digestate 202 may include undigested fibrous or particulate matter such as cellulose, clay, sand, and bone fragments. The digestate 202 may be passed through one or more filters 204 to remove the solid matter and to produce a filtered digestate 208 and sludge 206. The step 102 of filtering the digestate 202 may help to reduce or prevent plugging of a forward osmosis membrane. Filtration may be stepwise to remove solid matter in stages of decreasing particle size down to about 100 μm or less, about 50 μm or less, about 25 μm or less, about 20 μm or less, about 1 μm to about 100 μm, about 5 μm to about 100 μm, about 10 μm to about 100 μm, about 20 μm to about 100 μm, about 50 μm to about 100 μm, about 1 μm to about 80 μm, about 1 μm to about 60 μm, about 1 μm to about 40 μm, about 1 μm to about 20 μm, or about 5 μm to about 25 μm.

The filtering step 102 may be performed at any time during performance of the methods disclosed herein. Filtering the digestate 202 before performing forward osmosis, as shown in FIGS. 2 and 3, helps to reduce or prevent clogging of osmosis system components.

The sludge 206, which may include the undigested fibrous or particulate matter, may be composted as shown in FIGS. 2 and 3.

### Forward Osmosis

Methods disclosed herein include performing forward osmosis 210 on a digestate 202 to transfer nitrogen and water from the digestate 202 to a draw solution 214, thereby concentrating the digestate 202 and reducing the amount of nitrogen in the digestate 202. In embodiments, the forward osmosis membrane permits water and neutral nitrogen species to cross, but does not permit charged nitrogen ion species to cross, which aids in concentrating and reducing the nitrogen content of the digestate 202. In embodiments, a pH differential between the digestate 202 and draw solution 214 aids in the transfer of nitrogen as a neutral species from the digestate 202 to the draw solution 214 and the retention of nitrogen as a charged species in the draw solution 214.

In the system or process of forward osmosis 210, two solutions are brought into contact with opposite sides of a semipermeable membrane. Water can diffuse freely through the membrane while most dissolved species are substantially blocked. If one of the two solutions has a higher concentration of dissolved species, water will move from the solution with fewer dissolved species into the solution with more dissolved species.

In some commercial forward osmosis systems, a large area of membrane is rolled into an element and the solution to be dewatered or concentrated (referred to as a “feed solution”) is pumped over one side of the membrane. A highly saline solution (referred to as a “draw solution”) is pumped across the other side of the membrane and water is drawn by osmosis from the feed solution into the draw solution. During the forward osmosis process, the feed solution is concentrated and the draw solution is diluted. The draw solution may be re-concentrated by a separate reverse osmosis process 230, as described in detail below.

The presently disclosed forward osmosis processes 210 may employ membrane modules such as those disclosed in PCT International Application No. PCT/US2016/053321 filed on 23 Sep. 2016, which is incorporated herein, in its entirety, by this reference.

Membranes used herein may be permeable to neutral nitrogen species, such as ammonia (NH₃), and impermeable to charged nitrogen species, such as ammonium cations (NH₄⁺). For example, the membrane may have a permeability to ammonia up to about 10,000 times higher than a permeability to ammonium ions. The membrane may permit passage of ammonia at a rate similar to that of water. The membrane may be constructed of a cellulose ester.

In the presently disclosed methods, the forward osmosis feed solution 212 may be any one or more of the digestate 202, filtered digestate 208, or aerobically digested digestate, which is described in more detail below. In embodiments, as shown in FIGS. 2 and 3, the forward osmosis feed solution 212 is the filtered digestate 208.

The feed solution 212 may have a nitrogen content of about 0.1% to about 0.8%, about 0.12% to about 0.8%, about 0.15% to about 0.8%, about 0.2% to about 0.8%, about 0.4% to about 0.8%, about 0.1% to about 0.7%, about 0.1% to about 0.6%, about 0.1% to about 0.5%, about 0.1% to about 0.4%, or about 0.2% to about 0.5%.

The feed solution 212 may have a pH of about 7 to about 9, about 7.5 to about 8.5, about 7.5 to about 8, or about 8. The pH of the feed solution 212 may be adjusted by the addition of acid or base, as desired, or may be processed by forward osmosis without adjusting the pH.

In embodiments, anaerobic digestion of biomatter produces an effluent (digestate) having a pH of about 8. The digestate 202 is processed by forward osmosis without adjusting the pH. Without being limited to any mechanism or mode of action, the anaerobic digestion produces ammonia and carbon dioxide and the two compounds combine in solution to form ammonium bicarbonate. The gas/solution equilibrium of ammonium bicarbonate drives the digestate 202 to a pH of about 8. Ammonia has a pKa of 9.4; at a pH of about 8, about 88% is in the NH₄⁺ form and about 12% is in the NH₃ form. Carbon dioxide has a pKa of 6.4; at a pH of about 8, about 97% is in the HCO₃⁻ (bicarbonate) form and about 3% is in the H₂CO₃ form (carbonic acid). Accordingly, a digestate 202 having a pH of about 8 has a greater percentage of its nitrogen content in the form of ammonium ions than in the form of ammonia.

The forward osmosis draw solution 214 includes at least one acid or salt of an acid. The acid may be organic or inorganic. Examples of acids include acetic acid, citric acid, hydrochloric acid, maleic acid, nitric acid, phosphoric acid, sulfuric acid, and combinations thereof. In one embodiment, the draw solution 214 includes sulfuric acid and/or ammonium sulfate.

The draw solution 214 may have a pH of about 5 or less, about 4 or less, or about 3 to about 5. In an embodiment, the draw solution 214 has a pH of about 4.3. The pH of the draw solution 214 may be adjusted by the addition of acid. At a pH of about 5 or less, the ammonium/ammonia equilibrium is about 99.9995% Nhd 4⁺ and about 0.0005% NH₃. At a pH of about 5 or less, the carbon dioxide/bicarbonate equilibrium is about 99.5% CO₂ and about 0.5% HCO₃⁻.

A feed solution 212 having a pH of about 7 to about 9 has a greater percentage of its nitrogen content in the form of ammonia (e.g., 12% NH₃) than does a draw solution 214 having a pH of about 5 or less (e.g., 0.0005% NH₃).

The feed solution 212 and draw solution 214 may have a pH differential of about 2 to about 6, about 3 to about 6, about 4 to about 6, about 2 to about 5, about 2 to about 4, about 3 to about 4.5, or about 3.5 to about 3.9. A pH difference between the solutions may help achieve or maintain higher percentage of ammonia in the feed solution 212 than in the draw solution 214. In an embodiment, a feed solution 212 having a pH of about 7 to about 9 has a greater percentage of its nitrogen content in the form of ammonia (e.g., 12% NH₃) than does a draw solution 214 having a pH of about 5 or less (e.g., 0.0005% NH₃). A pH different between the solutions may allow ammonia in the feed solution 212 to move to the draw solution 214, thereby reducing the nitrogen load in the feed solution 212.

In embodiments, the concentration of ammonia is greater in the feed solution 212 than in the draw solution 214 and ammonia in the feed solution 212 moves across the ammonia-permeable forward osmosis membrane to the draw solution 214. In the draw solution 214, the pH is acidic and ammonia converts to the ammonium cation. The ammonium cation cannot return to the feed solution 212 because the membrane is relatively impermeable to ammonium cations. Nitrogen is thereby transferred from the feed solution 212 to the draw solution 214.

In embodiments, the concentration of bicarbonate anions is greater in the feed solution 212 than in the draw solution 214 and bicarbonate anions in the feed solution 212 move across the bicarbonate-permeable forward osmosis membrane to the draw solution 214. In the draw solution 214, the pH is acidic and HCO₃⁻ coverts to H₂CO₃. Carbon dioxide has a solubility of about 1000 ppm in the draw solution 214 and excess CO₂, such as that entering from the feed solution 212, is released as a gas from the draw solution 214.

During forward osmosis, acid 216 may be added to the draw solution 214 to maintain a desired pH, such as about 5 or less or about 4.3. Maintaining the desired pH may help to maintain the concentration of ammonia in the draw solution lower than the concentration of ammonium ions in the draw solution. Maintaining the desired pH may help to maintain the concentration of ammonia in the draw solution lower than the concentration of ammonia in the feed solution 212. Maintaining the desired pH may help to permit the diffusion of nitrogen from the feed solution 212 to the draw solution 214. The acid 216 may be any acid described above. The acid 216 may be the same acid as that used to acidify the draw solution 214 prior to the start of forward osmosis. In one embodiment, the acid 216 is sulfuric acid.

In the methods disclosed herein, the step 104 of forward osmosis reduces the volume of the feed solution, reduces the nitrogen content of the feed solution 212, increases the volume of the draw solution 214, and/or increases the nitrogen content of the draw solution 214.

Forward osmosis produces a digestate concentrate 228 from the digestate 202 or filtered digestate 208 feed solution 212. The volume of the digestate concentrate 228 may be less than about 40% of the volume of the feed solution 212 prior to performing forward osmosis, less than about 30%, less than about 20%, less than about 10%, about 5% to about 40%, about 10% to about 30%, or about 20% of the volume of the feed solution 212 prior to performing forward osmosis.

The nitrogen content of the digestate concentrate 228 may be about 0.25% to about 1.8%, about 0.3% to about 1.8%, about 0.5% to about 1.8%, about 0.75% to about 1.8%, about 1% to about 1.8%, about 1.25% to about 1.8%, about 1.5% to about 1.8%, about 0.25% to about 1.5%, about 0.25% to about 1%, about 0.25% to about 0.75%, about 0.25% to about 0.5%, or about 0.5% to about 1.25%.

The nitrogen content of the digestate concentrate 228 may be about 1% to about 50% of the nitrogen content of the feed solution 212 prior to performing forward osmosis, about 1% to about 40%, about 1% to about 30%, about 1% to about 20%, about 1% to about 10%, about 2% to about 50%, about 5% to about 50%, about 10% to about 50%, about 20% to about 50%, about 30% to about 50%, or about 5% to about 30% of the nitrogen content of the feed solution 212 prior to performing forward osmosis.

Forward osmosis produces a diluted draw solution 218 from the draw solution 214. The volume of the diluted draw solution 218 is greater than the volume of the draw solution 214 prior to performing forward osmosis. The volume may increase due to any one or more of the diffusion of water from the feed solution 212 to the draw solution 214, the diffusion of ammonia from the feed solution 212 to the draw solution 214, or the addition of acid 216 to the draw solution 214.

The nitrogen content of the diluted draw solution 218 may be greater than the nitrogen content of the draw solution 214 prior to performing forward osmosis. The increase in nitrogen content may approximate the decrease in nitrogen content from the feed solution 212 to the digestate concentrate. 228

The digestate concentrate 228 may rich in potassium and/or phosphate. The digestate concentrate 228 may be applied to land as potassium- or phosphate-rich solution. Alternatively or additionally, the digestate concentrate 228 may be further processed, such as by subjecting it to aerobic digestion or removing phosphorus from it, each as described below.

### Aerobic Digestion

The digestate 202 may include large amounts of undigested cellular material such as macromolecules including cellulose, lignin, proteins, and extracellular polysaccharides. Such macromolecules can cause high viscosity levels in digestates 202 and can set to form a gel-like solid at low temperatures or stagnant flows. High viscosity reduces the ability to concentrate the digestate 202.

The macromolecules are generally amenable to aerobic but not anaerobic digestion. The digestate 202 may be anaerobically digested to break down undigested material so as to reduce the viscosity of the digestate 202, which may permit further concentration of the digestate 202. Anaerobic digestion may lower the biological oxygen demand of the digestate 202, and release phosphate from some macromolecules.

The aerobic digestion 232 may be performed by bubbling gas through the digestate 202 or digestate concentrate 228. The step 106 of aerobic digestion may be performed for a period of time short enough to reduce or limit the stripping of ammonia from the digestate 202 or digestate concentrate 228 by air utilized in the aerobic digestion process. The aerobic digestion may be performed for less than 48 hours, less than 36 hours, less than 24 hours, or less than 12 hours.

The aerobic digestion step 106 may be performed at any time during performance of the methods disclosed herein. Aerobic digestions may be performed on the digestate 202, filtered digestate 208, or digestate concentrate 228. With reference to FIG. 2, performing forward osmosis before performing aerobic digestion helps to concentrate the digestate 202 and thereby reduce the requisite aerobic digester tank size. Performing aerobic digestion during concentration by forward osmosis, as shown in FIG. 3, helps to both reduce aerobic digester tank size and reduce or avoid fouling of the forward osmosis membranes.

Aerobic digestion may produce sludge 234, which may include undigested or indigestible material from the digestate 202. The sludge 234may be returned to digester feed as shown in FIGS. 2 and 3.

### Struvite Production

The digestate 202 may include phosphorus, which may be present at levels too high to apply to the land in some jurisdictions, such as due to regulatory restrictions. The phosphorus, as well as some nitrogen, may be removed in the form of struvite 240 (magnesium ammonium phosphate; MgNH₄PO₃). Generation and collection of struvite 240 may help reduce phosphorus or nitrogen concentrations such that the digestate 202 can be applied to land without causing environmental damage. Generation and collection of struvite 240 may help extract phosphorus and nitrogen from the digestate 202 to produce an economically valuable struvite fertilizer.

Struvite 240 is an insoluble salt and will precipitate out of the digestate 202. Struvite 240 may be produced by the addition of a magnesium salt, such as magnesium carbonate, to the digestate 202, which may include little or no magnesium. Addition of magnesium 238 may result in the precipitation of all or nearly all of the phosphorus in the digestate 202. In some implementations, the pH of the digestate 202 may be increased to aid in the generation and precipitation of struvite 240.

Magnesium 238 may be added to, and struvite 240 may accordingly be removed from, the digestate 202, filtered digestate 208, digestate concentrate 228, or aerobically digested concentrate 236. In the embodiments depicted in FIGS. 2 and 3, magnesium 238 is added to and struvite 240 is removed from the aerobically digested concentrate 236.

After removal of phosphorus and some nitrogen in the form of struvite 240 from the aerobically digested concentrate 236, some or all of the remaining aerobically digested concentrate 236 may be returned to the feed stream of the digester, such as along with farm and food waste. Returning the aerobically digested concentrate 236 to the digester reduces or eliminates the need to store the aerobically digested concentrate 236, which reduces costs.

Prior removal of phosphorus and some nitrogen in the form of struvite 240 helps produce a aerobically digested concentrate 236 that is suitable for environmentally safe land application. Some or all of the aerobically digested concentrate 236 may be applied to land, with or without storage. Applying the aerobically digested concentrate 236 to land reduces the buildup of salts in the digestate 202. Applying the aerobically digested concentrate 236 to land may reduce or eliminate the need to store the aerobically digested concentrate 236, which reduces costs.

### Reverse Osmosis

In the methods disclosed herein, a step 110 of reverse osmosis may be performed, which may produce an ammonium salt fertilizer. In the system or process of reverse osmosis 230, water under pressure is pushed across a semi-permeable membrane to separate water and dissolved material, such as salts. With reference to FIGS. 2 and 3, the diluted draw solution 218 produced during forward osmosis is used as the feed solution 220 in reverse osmosis. The diluted draw solution 218 is brought in contact with a semipermeable membrane at high pressure while forcing water through the membrane to produce a concentrate 222 and water 226, as shown in FIGS. 2 and 3. The concentrate 222 may be used as a nitrogen fertilizer.

The diluted draw solution 218 includes ammonium ions. In embodiments, the diluted draw solution 218 has a percentage of ammonium ions greater than a percentage of ammonia. Without being limited to any mechanism or mode of action, ammonia in the forward osmosis feed solution 212 diffuses into the draw solution 214, where the acidic pH converts the ammonia to ammonium ions. The ammonium ions react with an acid 216 in the diluted draw solution 218 to produce ammonium salts 224 in the concentrate 222. Examples of ammonium salts 224 include ammonium acetate, ammonium chloride, ammonium citrate, ammonium maleate, ammonium nitrate, ammonium phosphate, and ammonium sulfate. In an example, ammonium ions react with sulfuric acid to produce ammonium sulfate.

Ammonium salts 224, such as ammonium sulfate, may be concentrated to greater than 150,000 ppm during reverse osmosis, greater than 100,000 ppm, greater than 75,000 ppm, greater than 50,000 ppm, from about 50,000 ppm to about 150,000 ppm, from about 100,000 ppm to about 150,000 ppm, or from about 50,000 ppm to about 100,000 ppm during reverse osmosis.

The concentrate 222 may include ammonium salts 224 and water. The concentrate 222 may include about 8% to about 25% ammonium salts 224, about 10% to about 25%, about 15% to about 25%, about 20% to about 25%, about 8% to about 20%, about 8% to about 15%, or about 8% to about 10% ammonium salts 224. In an example, the concentrate 222 includes about 15% to about 17% ammonium sulfate and about 83% to about 85% water.

The concentrate 222 may be dried to remove water. The concentrate 222, with or without drying, may be stored until needed or until application to the land will not result in nutrient runoff. The concentrate 222, with or without drying, may be used as an ammonium salt fertilizer.

The water 226 produced by reverse osmosis may be used as process water, digester feed water, irrigation water, or the water may be land applied without also applying an excess of nutrients.

Compared to other methods of treating effluent from biomatter digesters, the presently disclosed methods remove more water and remove more ammonia. The ability to concentrate effluent more than other methods helps dairy farmers maintain herd size without exceeding limits on nutrient production and application to the land. The presently disclosed methods help the agricultural industry comply with environmental regulations regarding nutrient application to the land and limiting nutrient runoff. The presently disclosed methods may provide a revenue source from selling ammonium salt fertilizers and struvite fertilizers.

While various aspects and embodiments have been disclosed herein, other aspects and embodiments are contemplated. The various aspects and embodiments disclosed herein are for purposes of illustration and are not intended to be limiting.

What is claimed is:

1. A method of concentrating digestate from a biomass digester, the method comprising:
filtering solid matter from the digestate to produce a filtered digestate having a first amount of ammonia; and
performing forward osmosis with a draw solution and the filtered digestate as a feed solution to produce, from the filtered digestate and the draw solution, a digestate concentrate having a second amount of ammonia,
wherein the second amount of ammonia is less than the first amount of ammonia.

2. The method of claim 1, wherein the draw solution has a third amount of ammonia and the third amount of ammonia is less than the first amount of ammonia.

3. The method of claim 1, wherein the draw solution has a pH that is lower than a pH of the filtered digestate.

4. The method of claim 1, wherein a difference between the pH of the filtered digestate and the pH of the draw solution is from about 2 to about 6.

5. The method of claim 1, wherein the forward osmosis is performed using a membrane having a permeability to ammonia greater than a permeability to ammonium ions.

6. The method of claim 5, wherein the membrane includes a cellulose ester.

7. The method of claim 1, further comprising aerobically digesting one or more of the digestate, the filtered digestate, or the digestate concentrate to reduce the amounts of undigested cellular material.

8. The method of claim 7, wherein aerobically digesting is performed for less than 48 hours.

9. The method of claim 1, wherein the draw solution includes an acid selected from acetic acid, citric acid, hydrochloric acid, maleic acid, nitric acid, phosphoric acid, sulfuric acid, and combinations thereof.

10. A method of removing nitrogen from a feed solution, the method comprising:
providing the feed solution including nitrogen in the form of at least ammonia and ammonium ions;
providing a draw solution; and
performing forward osmosis with the feed solution and the draw solution to transfer ammonia from the feed solution to the draw solution,
wherein the amount of nitrogen in the feed solution is reduced by up to about 50%.

11. The method of claim 10, further comprising adding acid to the draw solution during forward osmosis such that a concentration of ammonia in the draw solution is maintained lower than a concentration of ammonia in the feed solution.

12. The method of claim 10, wherein a difference between the pH of the feed solution and the pH of the draw solution is from about 2 to about 6.

13. The method of claim 10, wherein the feed solution has a pH from about 7 to about 9 and the draw solution has a pH of about 5 or less.

14. The method of claim 10, wherein the forward osmosis is performed using a membrane having a permeability to ammonia that is greater than a permeability to ammonium ions.

15. The method of claim 13, wherein the membrane includes a cellulose ester.

16. A method of producing fertilizer, the method comprising:
performing forward osmosis with a feed solution and a draw solution to produce, from the draw solution, a diluted draw solution having a percentage of ammonium ions greater than a percentage of ammonia;
performing reverse osmosis on the diluted draw solution to produce a concentrate; and
allowing the ammonium ions in the diluted draw solution to react with an acid in the diluted draw solution to produce an ammonium salt in the concentrate,
wherein the concentrate forms a fertilizer.

17. The method of claim 16, wherein the ammonium salt includes one or more of ammonium acetate, ammonium chloride, ammonium citrate, ammonium maleate, ammonium nitrate, ammonium phosphate, or ammonium sulfate.

18. The method of claim 16, further comprising adding magnesium salt to the feed solution to produce struvite.

19. The method of claim 18, further comprising precipitating and collecting the struvite as a fertilizer.

20. The method of claim 18, wherein the magnesium salt includes magnesium carbonate.

21. A method of processing digestate from a biomass digester, the method comprising:
filtering solid matter from the digestate to produce a filtered digestate having a first amount of ammonia;
performing forward osmosis with a draw solution having a second amount of ammonia, and the filtered digestate as a feed solution;
producing, from the filtered digestate and the draw solution:
a digestate concentrate having a third amount of ammonia, and
a diluted draw solution having a fourth amount of ammonia that is less than an amount of ammonium ions in the diluted draw solution;
performing reverse osmosis on the diluted draw solution to produce a concentrate;
allowing the ammonium ions in the diluted draw solution to react with an acid in the diluted draw solution to produce an ammonium salt in the concentrate; and
adding magnesium salt to the feed solution to produce struvite;
wherein the first amount of ammonia is greater than the third amount of ammonia;
the fourth amount of ammonia is greater than the second amount of ammonia;
the concentrate forms a fertilizer; and
the struvite forms a fertilizer.
